(19) United States
(12) Patent Application Publication
(10) Pub. No.: US 2013/0234371 A1
(43) Pub. Date: Sep. 12, 2013

(54) IMPRINT APPARATUS, AND ARTICLE MANUFACTURING METHOD USING SAME

(71) Applicant: CANON KABUSHIKI KAISHA, Tokyo (JP)

(72) Inventors: Naoki Yamaguchi, Utsunomiya-shi (JP); Masayoshi Fujimoto, Utsunomiya-shi (JP)

(73) Assignee: CANON KABUSHIKI KAISHA, Tokyo (JP)

(21) Appl. No.: 13/789,834

(22) Filed: Mar. 8, 2013

(30) Foreign Application Priority Data
Mar. 12, 2012 (JP) 2012-054892

(51) Int. Cl. B29C 59/16

(52) U.S. Cl. CPC B29C 59/16
USPC 264/446; 425/174.4

(57) ABSTRACT

An imprint apparatus molds a resin on a substrate with a mold and cures it by irradiation with a light to form a pattern on the substrate. This imprint apparatus includes an light irradiation unit configured to irradiate the light, and a mold holding unit configured to hold the mold, and at which an opening is formed to allow passage of the light irradiated from the light irradiation unit toward the substrate via the mold. Here, at least a portion of the surface of the mold holding unit which a reflected light that is reflected by at least either the substrate or the mold is can be incident has a reflectance that is lower than the reflectance of the surface of the mold relative to the light that is irradiated from the light irradiation unit.

### BACKGROUND OF THE INVENTION

1. Field of the Invention

The present invention relates to an imprint apparatus and an article manufacturing method using the same.

2. Description of the Related Art

As requirements for miniaturization of semiconductor devices, MEMS and the like have advanced, attention is being focused not only on conventional photolithography technology, but also on microfabrication technology which molds resin with a mold on a substrate (wafer) to form a resin pattern on the substrate. This technology is referred to as imprint technology, and enables formation of miniature structures on the order of several nanometers on a substrate. For example, as one imprint technique, there is the photo-curing method. With imprint apparatuses adopting this photo-curing method, firstly, a resin (imprint material, photo-curing resin, ultraviolet-curing resin) is applied to a shot which is a pattern formation region on the substrate. Next, this resin is molded using a mold on which a pattern is formed. A resin pattern is then formed on the substrate by releasing the mold after the resin is cured by irradiation with light.

Generally, in such imprint apparatus, a resin is applied by the multiple shots existing on the substrate, and pattern formation is repeated for each individual shot. In contrast, from the standpoint of improving throughput, there is also the case where resin is collectively applied for the multiple shots on the substrate, and pattern formation is repeated with respect to each individual shot. In this case, when the resin on a desired shot is irradiated with light after molding, light is reflected at the interface of the resin and the substrate, raising the possibility that the reflected light may cure not only the resin on the desired shot, but also the resin for which curing is not intended on neighboring shots. In order to avoid such inadvertent curing of resin, Japanese Patent Application Laid-Open No. 2010-258259 discloses a mold (an imprint transfer substrate) which causes the resin on the desired shot to be efficiently irradiated with curing light by providing a light-reflecting film on the pattern portion formed on the mold. Furthermore, as another aspect of Japanese Patent Application Laid-Open No. 2010-258259, inadvertent curing of resin can be avoided by providing an anti-reflecting film on a part of the surface of the mold, and suppressing much of the reflected light (scattered light) from the substrate side.

However, although the mold shown in Japanese Patent Application Laid-Open No. 2010-258259, can suppress the scattering of light that is reflected by the substrate side, the possibility remains that light may be reflected at the pattern portion of the mold. The light that is reflected by the pattern portion is reflected by the interior of the apparatus, raising the possibility that the resin for which curing is not intended may be cured. Therefore, further improvements are desirable in order to eliminate the possibility of inadvertently irradiating resin with light.

### SUMMARY OF THE INVENTION

The present invention provides an imprint apparatus which is advantageous for inhibiting light that cures resin from irradiating resin for which curing is not intended.

According to an aspect of the present invention, an imprint apparatus which forms a pattern on a substrate by irradiating a light in a state where a mold and an imprint material on the substrate are brought into contact includes an light irradiation unit configured to irradiate the light, and a mold holding unit configured to hold the mold, and at which an opening is formed to allow passage of the light irradiated from the light irradiation unit toward the substrate via the mold, wherein at least a portion of the surface of the mold holding unit which a reflected light that is reflected by at least either the substrate or the mold is can be incident has a reflectance that is lower than the reflectance of the surface of the mold relative to the light that is irradiated from the light irradiation unit.

According to the present invention, it is possible to provide an imprint apparatus which is advantageous for inhibiting light that cures resin from irradiating resin for which curing is not intended.

Further features of the present invention will become apparent from the following description of exemplary embodiments (with reference to the attached drawings).

### BRIEF DESCRIPTION OF THE DRAWINGS

FIG. 1 is a drawing which shows the configuration of the imprint apparatus of an embodiment of the present invention.

FIG. 2 is a drawing which shows the configuration of an imprint apparatus of an embodiment of the present invention.

FIG. 3 is a drawing which shows incident light and reflected light of ultraviolet rays in a conventional imprint apparatus.

### DESCRIPTION OF THE EMBODIMENTS

Hereinafter, preferred embodiments of the present invention will now be described in detail with reference to the accompanying drawings.

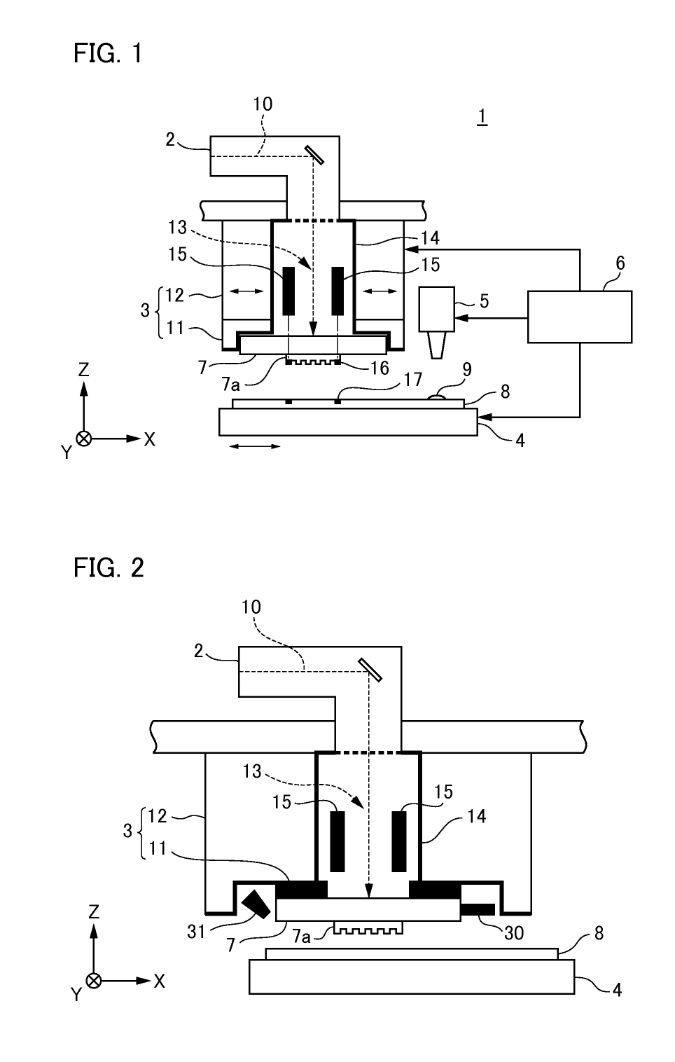

Firstly, a description is given of the imprint apparatus according to an embodiment of the present invention. FIG. 1 is a schematic drawing which shows the configuration of an imprint apparatus 1 of the present embodiment. The imprint apparatus 1 is used to manufacture devices such as semiconductor devices as articles, and is an apparatus which uses a mold to form a pattern on a wafer (on a substrate) in resin that is supplied onto the wafer. Here, the imprint apparatus 1 is configured to adopt the photo-curing method that cures resin by irradiation with light. In the following drawings, a Z axis is adopted which is parallel to the optical axis of the illumination system that irradiates the resin on the wafer with light, and an X axis and a Y axis are adopted which are mutually orthogonal in a plane that is perpendicular to the Z axis. As shown in FIG. 1, an XYZ coordinate system is adopted for the imprint apparatus. The imprint apparatus 1 comprises a light irradiation unit 2, a mold holding mechanism 3, a wafer stage 4, an application unit 5, and a control unit 6.

The light irradiation unit 2 irradiates a resin 9 on a wafer 8 with ultraviolet rays 10 through a mold 7, and thereby the resin 9 is cured. In the present embodiment, the irradiated light is an ultraviolet rays, and the resin 9 (imprint material) is an ultraviolet-curing resin. The light irradiation unit 2 includes a light source and an optical system. Although not illustrated in the drawings, the light source may include a high-pressure mercury lamp which generates ultraviolet rays (e.g., i rays, g rays), and an elliptical mirror which condenses the generated light. The light source is not limited to a high-pressure mercury lamp, and it is also possible to adopt, for example, various types of excimer lamps, excimer lasers, or light-emitting diodes. The optical system includes a lens, an aperture and a half mirror for irradiating the resin 9 on a shot with the ultraviolet rays 10. The aperture is used for controlling field angle and peripheral light-shielding. Depending on the field angle control, it is possible to irradiate only a target shot, and depending on peripheral light-shielding control, it is possible to restrict the ultraviolet rays 10 so that the ultraviolet rays 10 do not irradiate beyond the contours of the wafer 8. The optical system may also be configured to include an optical integrator for uniformly illuminating the mold 7. The ultraviolet rays 10, of which the range of illumination is defined by the aperture, are incident upon the resin 9 on the wafer 8 via the mold 7. The irradiation region (irradiation range) of the ultraviolet rays 10 irradiated by the light irradiation unit 2 is preferably identical to the region of a pattern portion 7a formed on the mold 7, or slightly larger than the region of the pattern portion 7a. This is in order to inhibit expansion of the mold 7 or the wafer 8 due to the heat associated with irradiation, and occurrence of dislocation or distortion in the pattern formed on the resin 9 by keeping the irradiation region to the necessary minimum. In addition, since the resin 9 is ultraviolet-curing resin, the wavelength of the light that irradiates the resin 9 is preferably a wavelength in the ultraviolet region. For example, considered in terms of the effects of wavelength interference from other detection systems and the like, 400 nm or less which is the wavelength band of the ultraviolet rays 10 would be ideal. Furthermore, the light that is irradiated for curing resin may be determined according to the properties of the employed photo-curing resin.

The circumferential shape of the mold 7 is polygonal (ideally, rectangular or square), and the face opposing the wafer 8 includes a pattern portion 7a on which a fine textured pattern such as a circuit pattern is formed for transfer. The material of the mold 7 is capable of transmitting the ultraviolet rays 10, and preferably has a low coefficient of thermal expansion—for example, quartz could be used. Furthermore, the mold 7 may have a cavity, of which the planar shape may be circular and that has a certain depth, on the surface that is irradiated by the ultraviolet rays 10 (the surface on which the pattern portion 7a is not formed).

The mold holding mechanism (mold holding unit) 3 includes an imprint head 11 which includes a mold chuck that holds the mold 7, and a mold drive mechanism 12 that moves the imprint head 11 (the mold 7). The mold drive mechanism 12 may include a positioning mechanism which controls the position of the mold 7 relative to the six axes, and a mechanism which brings the mold 7 into contact with the resin 9 on the wafer 8, and which releases the mold 7 from the cured resin 9. Here, the six axes are the X axis, Y axis, and Z axis in the XYZ coordinate system of the imprint apparatus, and the rotation around each of these axes. Furthermore, the imprint head 11 and the mold drive mechanism 12 have an open region (opening) 13 at the center (inner side) in the planar direction of the mold 7 through which the ultraviolet rays 10 irradiated from the light irradiation unit 2 can pass toward the wafer 8. In this manner, the mold holding mechanism 3 is provided with an open region 13 through which the ultraviolet rays 10 pass. Otherwise, as shown in FIG. 2, the mold holding mechanism 3 may also include a magnification correction mechanism 30 which corrects the shape of the mold 7 (the pattern portion 7a) by mechanically applying external force or displacement to a side face of the mold 7.

In the present embodiment, an anti-reflection unit (optical member) 14 is formed on a region which can be irradiated with reflected light (scattered light) from the mold 7 itself or the wafer 8 side when the ultraviolet rays 10 are irradiated from the light irradiation unit 2, in the imprint head 11 and the open region 13. In FIG. 1, this anti-reflection unit 14 is shown by a bolded solid line that encloses the mold 7. Specifically, the anti-reflection unit 14 is formed on the surface of the imprint head 11 that spatially communicates with the wafer 8 (the surface where the imprint head 11 opposes the wafer 8). Also, the anti-reflection unit 14 is formed on at least a portion or over the entire surface of the surface where the imprint head 11 and the mold 7 are opposed (near the mold holding face), and the surface that can be irradiated by the reflected light that passes through the mold 7 within the open region 13. The anti-reflection unit 14 may be a member having a surface with anti-reflection properties, e.g., an anti-reflection film. Or the anti-reflection unit 14 may be a film which is surface treated to a surface that does not have anti-reflection properties so as to have anti-reflection properties. The anti-reflection unit 14 may be newly provided a member that is different from the members configuring the imprint apparatus, or may be provided a film on the surface of the members configuring the imprint apparatus. In the case where the material of the mold 7 is quartz, when the wavelength of the ultraviolet rays 10 is 200-400 nm, the reflectance of the mold 7 at vertical incidence is on the order of 3.6-4.6%. Consequently, the reflectance of the anti-reflection unit 14 is preferably set to 3% or less. For example, considered in terms of surface treatment for obtaining anti-reflection properties, black plating (black electroless nickel plating, black zinc plating) having reflectance of 1% or less in the wavelength band of the ultraviolet rays 10 would be ideal. In this manner, the reflection within the imprint apparatus can be effectively reduced by providing an anti-reflection unit having a reflectance that is lower than the reflectance of the mold relative to the light that cures the resin.

The wafer 8 is, for example, a single-crystal silicon substrate, an SOI (silicon-on-insulator) substrate, or a glass substrate. A pattern (a layer containing a pattern) of the resin 9 is formed on the multiple shots (pattern formation regions) on this wafer 8 by the pattern portion 7a. A pattern (substrate side pattern) may be already formed in a previous step in the pattern formation regions prior to introduction into the imprint apparatus 1.

The wafer stage 4 includes a wafer chuck which attracts and holds the wafer 8 by vacuum absorption or the like, and a stage drive mechanism which moves the wafer chuck (wafer 8). The stage drive mechanism includes a positioning mechanism which controls the position of the wafer 8 by controlling the six axes in the same manner as the mold drive mechanism 12 controls the position of the wafer chuck.

The application unit 5 (dispenser) applies the resin 9 (the imprint material) to the shots on the wafer 8. This application unit 5 includes a tank which stores the resin 9, a discharge port which discharges the resin 9 supplied through a supply channel from this tank to the wafer 8, and the like.

The control unit 6 may control the operations, adjustments and the like of the various components of the imprint apparatus 1. The control unit 6 is configured by, for example, a computer or the like, is connected to the various components of the imprint apparatus 1 via a line so as to execute control of the various components according to a program or the like. In addition to the case where the resin 9 is applied to one shot for a single pattern formation, the control unit 6 of the present embodiment may also execute control that repeats pattern formation (pressing operations and the like) after the resin 9 has been applied in advance to multiple shots. The control unit 6 may be integrally configured (in a shared casing) with the other components of the imprint apparatus 1, or it may be separately configured (in a separate casing) without the other components of the imprint apparatus 1.

The imprint apparatus 1 is also provided with an alignment measurement system 15. This alignment measurement system 15 includes multiple alignment scopes (not shown) and alignment scope drive mechanisms. For positioning the mold 7 and the wafer 8, an alignment scope detects alignment marks 16 formed on the mold 7 and alignment marks 17 formed on the wafer 8 via the mold 7. The alignment scope drive mechanisms are capable of individually moving the multiple alignment scopes, and changing detection positions. Furthermore, the imprint apparatus 1 includes a mold conveyance mechanism which conveys the mold 7 between the exterior of the apparatus and the mold holding mechanism 3, a substrate conveyance mechanism which conveys the wafer 8 between the exterior of the apparatus and the wafer stage 4, and the like.

Next, a description is given of the imprint processing performed by the imprint apparatus 1. Firstly, the control unit 6 mounts and fixes a wafer 8 onto the wafer stage 4 using the substrate conveyance device. Next, while driving the stage drive mechanism and appropriately modifying the position of the wafer 8, the control unit 6 causes the alignment measurement system 15 to sequentially measure the alignment marks 17 on the wafer 8, and to detect the position of the wafer 8 with high-precision. The control unit 6 then calculates the various shot positions from the detection results, and forms a pattern for each predetermined shots based on these calculated results (step and repeat). As to the process of pattern formation for a given shot, first, the control unit 6 causes the stage drive mechanism to position the application position on the wafer 8 directly underneath the discharge port of the application unit 5. Then, the application unit 5 applies the resin 9 to the shot on the wafer 8 (application step). Next, the control unit 6 causes the stage drive mechanism to move and position the wafer 8 so that the shot is located at the pressing position directly underneath the pattern portion 7a. Next, after performing alignment of the pattern portion 7a and the substrate-side pattern on the shot, magnification correction of the pattern portion 7a by the magnification correction mechanism 30, and the like, the control unit 6 drives the mold drive mechanism 12, and presses the pattern portion 7a against the resin 9 on the shot (mold pressing step). By means of this pressing, the textured pattern of the pattern portion 7a is filled with the resin 9. The control unit 6 determines the completion of pressing using a load sensor (not shown) installed inside the mold holding mechanism 3. In this state, the light irradiation unit 2 irradiates the ultraviolet rays 10 from the rear face (top face) of the mold 7 for a predetermined period of time, and cures the resin 9 (curing step). After the resin 9 has been cured, the control unit 6 again drives the mold drive mechanism 12, and separates the pattern portion 7a and the wafer 8 (mold release step). By this means, a resin pattern of three-dimensional shape imitating the textured pattern of the pattern portion 7a is formed on the surface of the shot on the wafer 8. The imprint apparatus 1 is able to form multiple resin patterns on a single wafer 8 by performing this series of imprint operations multiple times while changing the shots by driving the wafer stage 4.

In the above imprint processing, the control unit 6 repeats the step in which a pattern is formed on an individual shot after application of the resin 9 to the shot according to the number of shots existing on the wafer 8. In contrast, there is also the case where the control unit 6 causes the application unit 5 to apply the resin 9 to multiple shots on the wafer 8, and repeats pattern formation with respect to each individual shot.

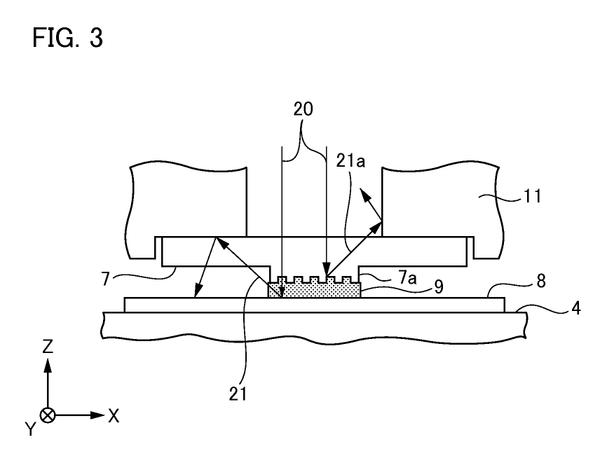

When the control unit 6 causes the light irradiation unit 2 to irradiate the resin 9 of the desired shot with the ultraviolet rays 10, the possibility exists that the ultraviolet rays 10 may be reflected at the interface of the wafer 8 and the resin 9. In addition, the possibility also exists that the ultraviolet rays 10 may be reflected by the rear face of the mold 7. FIG. 3 is a schematic drawing which shows incident light 20 and reflected light 21 and 21a of the ultraviolet rays 10 when the resin 9 on the wafer 8 is cured in a conventional imprint apparatus. In FIG. 3, for simplifying the description, the same reference numerals are assigned where the configuration is identical to that of the imprint apparatus 1 of the present embodiment, and description thereof is omitted. When the light irradiation unit 2 irradiates toward the wafer 8 with the ultraviolet rays 10, the incident light 20 of the ultraviolet rays 10 is vertically incident on the resin 9 relative to the wafer 8. However, the reflected light 21 is repeatedly scattered depending on the shape of surface without reflecting vertically, resulting in incident not only the resin 9 on desired shot, but also upon the uncured resin 9 applied on neighboring shots. Furthermore, reflection of the incident light 20 may occur not only on the wafer 8 side, but also, for example, at the pattern portion 7a formed on the mold 7. The reflected light 21a reflected by this pattern portion 7a is repeatedly scattered in the open region 13, and in this case, as well, is ultimately incident upon the uncured resin 9 applied to neighboring shots. In this manner, the possibility exists that the reflected light 21 and 21a may cure not only the resin 9 of the desired shot, but also the resin 9 of neighboring shots for which curing is not intended. In order to prevent irradiation of the substrate by this reflected light 21 and 21a, a light-reflecting film or an anti-reflection film may be formed on the mold. However, as the mold becomes contaminated by repeated contact with the resin, it is necessary to clean the mold. The durability of light-reflecting film or anti-reflection film with respect to cleaning is generally poor. Consequently, it is necessary to reproduce the light-reflecting film or anti-reflection film at each cleaning of the mold.

In the present embodiment, by installing the anti-reflection unit 14 at the appropriate positions in the above manner, the reflected light 21 and 21a is prevented from irradiating the resin 9 on neighboring shots for which curing is not intended. By this means, not only is it possible to inhibit reflection of the directly reflected light 21 from the wafer 8 side and from the mold 7 itself, but it is also possible to inhibit reflection of the indirectly reflected light 21a that is repeatedly scattered in the vicinity of the mold 7. In particular, an edge portion is present due to the structure of the imprint head 11. Here, the edge portion includes an angular portion of the imprint head 11 that determines the shape of the open region 13 when the open region 13 is viewed from the wafer stage 4. There is a risk that the ultraviolet rays reflected by the edge portion may irradiate unintended regions. Based on experimental results, arrangement of the anti-reflection unit 14 at this edge portion can be particularly effective.

The anti-reflection unit 14 is not limited to the above positions, and may also be set up (formed) at the following sites. Firstly, as described above, the alignment measurement system 15 is evacuated from the optical path of the ultraviolet rays 10 when the ultraviolet rays 10 are irradiated, but even when evacuated, so long as it is inside the open region 13, it may constitute a source of reflection upon receiving the reflected light 21a from the mold 7 (patterned portion 7a). Therefore, it is preferable to provide an anti-reflection unit identical to the anti-reflection unit 14 on at least part of the surface of the alignment measurement system 15. In FIG. 1, the alignment measurement system 15 is denoted by the blacked out sections, indicating that the anti-reflection unit 14 is provided on the surface thereof. In addition, an anti-reflection unit identical to the anti-reflection unit 14 may also be provided on at least a portion of the surface of the application unit 5.

Now, FIG. 2 is a schematic drawing which shows a configuration including a magnification correction mechanism (shape correction mechanism) 30 and a gas supply nozzle 31 that fills an interstice between the mold 7 and the wafer 8 with gas at least during pressing operations in the imprint apparatus 1 shown in FIG. 1. The magnification correction mechanism 30 is set up near the mold 7 in order to exert external force from the side face of the mold 7. The gas supply nozzle 31 is connected to a gas supply unit (not shown), and enhances the filling properties of the resin 9 to the pattern portion 7a by supplying, for example, a gas with excellent diffusability and solubility relative to the resin 9. This gas supply nozzle 31 is also set up near the mold 7. That is, this magnification correction mechanism 30 and gas supply nozzle 31 may also constitute a source of reflection upon receiving the reflected light 21 from the wafer 8 side. Therefore, an anti-reflection unit identical to the anti-reflection unit 14 is preferably provided on at least a portion of the surface of the magnification correction mechanism 30 or gas supply nozzle 31. In FIG. 2, the magnification correction mechanism 30 and gas supply nozzle 31 are denoted by blacked out sections, indicating that an anti-reflection unit is provided on the surface thereof.

As the imprint apparatus 1 sets up the anti-reflection unit 14 at the aforementioned positions (sites) in this manner, it is possible to inhibit the ultraviolet rays 10 from irradiating, for example, the resin 9 of shots adjacent to the desired shot for which curing is not intended during the curing step. Moreover, the ultraviolet rays 10 (reflected light 21) reflected by the wafer 8 and on the like cure the resin 9 remaining on the discharge port of the application unit 5, and thereby it is also possible to prevent occurrence of anomalies in the subsequent operations of the application unit 5. Furthermore, in the present embodiment, as light-reflecting film or anti-reflecting film is not formed on the mold 7 itself, there is no need for a step in which light-reflecting film or anti-reflecting film is reproduced after cleaning of the mold 7.

As shown above, according to the present embodiment, it is possible to offer an imprint apparatus which is advantageous for inhibiting the light that cures resin from irradiating resin for which curing is not intended.

The speed at which the resin 9 is cured (curing speed) is defined by the wavelength intensity and amount (irradiation time) of the ultraviolet rays 10 that cure the resin 9. That is, as the wavelength of the irradiated ultraviolet rays 10 is varied according to the resin 9 that is adopted, the reflectance of the anti-reflecting unit 14 should be lower than the specific wavelength of the ultraviolet rays 10. Thus, it is also effective to vary the material and structure of the anti-reflecting unit 14 according to the type of the resin 9 that is adopted. Furthermore, the description given herein concerns use of ultraviolet rays as the light that cures the resin 9, but the light wavelength should be suitably determined according to the type of the resin 9 that is supplied to the wafer 8.

### (Article Manufacturing Method)

A method for manufacturing a device (semiconductor integrated circuit element, liquid display element, or the like) as an article may include a step of forming a pattern on a substrate (wafer, glass plate, film-like substrate, or the like) using the imprint apparatus described above. Furthermore, the manufacturing method may include a step of etching the substrate on which a pattern has been formed. When other articles such as a patterned medium (storage medium), an optical element, or the like are manufactured, the manufacturing method may include another step of processing the substrate on which a pattern has been formed instead of the etching step. The article manufacturing method of the present embodiment has an advantage, as compared with a conventional article manufacturing method, in at least one of performance, quality, productivity and production cost of an article.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-054892 filed Mar. 12, 2012 which is hereby incorporated by reference herein in its entirety.

What is claimed is:

1. An imprint apparatus which forms a pattern on a substrate by irradiating a light in a state where a mold and an imprint material on the substrate are brought into contact, the imprint apparatus comprising:
an light irradiation unit configured to irradiate the light, and
a mold holding unit configured to hold the mold, and at which an opening is formed to allow passage of the light irradiated from the light irradiation unit toward the substrate via the mold,
wherein at least a portion of the surface of the mold holding unit which a reflected light that is reflected by at least either the substrate or the mold can be incident has a reflectance that is lower than the reflectance of the surface of the mold relative to the light that is irradiated from the light irradiation unit.

2. The imprint apparatus according to claim 1, wherein the mold holding unit comprises an optical member which has a reflectance lower than the reflectance of the surface of the mold relative to the light that is irradiated from the light irradiation unit.

3. The imprint apparatus according to claim 2, wherein the optical member is provided on at least either an entire surface of the opening that is formed at the mold holding unit, or a surface region of the mold holding unit that opposes the substrate.

4. The imprint apparatus according to claim 2, wherein the optical member is provided at least on an edge portion of the opening that is formed at the mold holding unit, among the surface region that opposes the substrate.

5. The imprint apparatus according to claim 2, wherein the optical member is a member having anti-reflection properties.

6. The imprint apparatus according to claim 2, wherein the surface of the optical member is a film having anti-reflection properties.

7. The imprint apparatus according to claim 6, wherein the film is a film that is subjected to black plating.

8. The imprint apparatus according to claim 2, comprising at least one of:
an application unit which applies the imprint material onto the substrate;
a magnification correction mechanism which corrects a shape of the mold; and
a gas supply nozzle which supplies gas between the mold and the substrate;
wherein the optical member is further provided on at least a portion of the surface of the application unit, the magnification correction mechanism, or the gas supply nozzle.

9. An article manufacturing method, comprising:
forming a pattern of an imprint material on a substrate using an imprint apparatus; and
processing the substrate that the pattern is formed; and
wherein the imprint apparatus which forms a pattern on a substrate by irradiation a light in a state where a mold and an imprint material on the substrate are brought into contact, and comprises:
an light irradiation unit configured to irradiate the light, and
a mold holding unit configured to hold the mold, and at which an opening is formed to allow passage of the light irradiated from the light irradiation unit toward the substrate via the mold;
wherein at least a portion of the surface of the mold holding unit which a reflected light that is reflected by at least either the substrate or the mold is capable incident has a reflectance that is lower than the reflectance of the surface of the mold relative to the light that is irradiated from the light irradiation unit.
